(19) United States
(12) Patent Application Publication
(10) Pub. No.: US 2015/0120333 A1
(43) Pub. Date: Apr. 30, 2015

(54) SYSTEMS AND METHODS FOR INSURANCE RATEMAKING USING WEATHER SCORE

(71) Applicant: AON BENFIELD INC., Chicago, IL (US)

(72) Inventors: STEPHEN CHARLES FIETE, EVANSTON, IL (US); STEPHEN JOHN MARTIN MILDENHALL, OAK PARK, IL (US)

(73) Assignee: AON BENFIELD INC., Chicago, IL (US)

(21) Appl. No.: 14/062,403

(22) Filed: Oct. 24, 2013

(51) Int. Cl. G06Q 40/08

(52) U.S. Cl. CPC G06Q 40/08
USPC 705/4

(57) ABSTRACT

Systems and methods of the present technology provide the capability to adjust historical claim frequency and/or claim severity data using a weather score process.

### FIELD OF THE INVENTION

The present technology relates to systems and methods for implementing weather score adjustments in the insurance ratemaking process.

### DESCRIPTION OF RELATED ART

Ratemaking for e.g., property-casualty insurance is the process that determines a price to underwrite the risk of prospective losses for a specific segment of the insurance business. Ratemaking typically involves the analysis of past exposure, premium, and loss data. Descriptions of widely used ratemaking methods are provided in Basic Ratemaking by Werner and Modlin. This text provides common methods of adjusting historical data so that the data is relevant for estimating prospective losses. There are other references that provide less common suggestions to ratemaking practitioners for adjusting data. These references include Foundations of Casualty Actuarial Science (4th edition) published by the Casualty Actuarial Society, An Actuarial Approach to Property Catastrophe Cover Rating, by Gogol; and Homeowners Premium Trend, by Brockmeier.

It is noted that methods used to adjust historical loss data for the ratemaking process will often make adjustments to claim count data (i.e., claim frequency) and claim severity data separately. For example, a belief that improvements in automobile tires, brakes, and suspension systems causes some practitioners to believe that the frequency of auto claims will decrease over time. As is known in the art, frequency in the auto insurance field is defined as the number of claims divided by the number of car-years over a specified period of time. Other practitioners, however, may believe that there is a trend of increasing body shop repair and medical costs. These trends would cause an in increase in cost per claim (i.e., severity). Based on this, a ratemaking practitioner would adjust down historical claim counts and adjust up the average cost per claim to predict the cost of prospective losses.

The fundamental premise of adjusting past loss data is the belief that the future will be predictably different from the past. Various forms of this premise are demonstrated in the practice of adjusting past loss data. Periods of time when catastrophic events have occurred have higher claim frequencies than average. Claim frequency data is thereby often adjusted to reflect what is believed to be average claim frequency. Typically, a ratemaking practitioner will adjust historical insurance data and aggregate it by year, quarter, or month. Even after making adjustments that are meant to restate claim frequencies and severities to a level that reflects prospective costs, there is often variation in the trended data by year, quarter or month. The aggregated trended data in each time period is meant to represent prospective costs. With each time period showing a different trended cost, the practitioner has a range of estimates for prospective cost, but must select just one number for each coverage he or she is making rates for. The variation in trended costs by time period is considered to be “random”. Random variation in indicated costs is a variation that cannot be explained by the practitioner.

Thus, there is a need and desire for enhancing the trending process so that the trended claim frequency and/or severity from past time periods is more representative of prospective costs.

### BRIEF DESCRIPTION OF THE DRAWINGS

Specific examples have been chosen for purposes of illustration and description, and are shown in the accompanying drawings, forming a part of the specification.

FIG. 1 illustrates a flowchart of an example process disclosed herein.

FIG. 2 illustrates an example weather scorecard according to the disclosed embodiments.

FIGS. 3a-3b illustrate the example application of a frequency weather scorecard and the resulting claim frequency adjustments according to a disclosed embodiment.

FIG. 4 illustrates one example of a computing device system of the present technology.

### DETAILED DESCRIPTION

The technology disclosed herein provides the capability to apply weather score processing to adjust historical claim frequency and/or severity data, which should decrease the random variation of indicated costs and improve the overall ratemaking process.

As used herein, weather score is a predictive modeling method that calculates the effect weather conditions and calendar properties have on frequency and/or severity of claims. “Weather conditions” are measurements, for a particular region, of e.g., temperature, precipitation (amount and type), and sunny/cloudy conditions. These measurements can be expressed both in absolute terms, or in terms relative to an average for a year, month, or day.

According to the disclosed principles, the measured weather conditions are used to adjust historical claim frequencies and/or severities by accounting for the level of claim measurement for the historical time period attributable to weather conditions and restating those measurements for weather conditions expected prospectively.

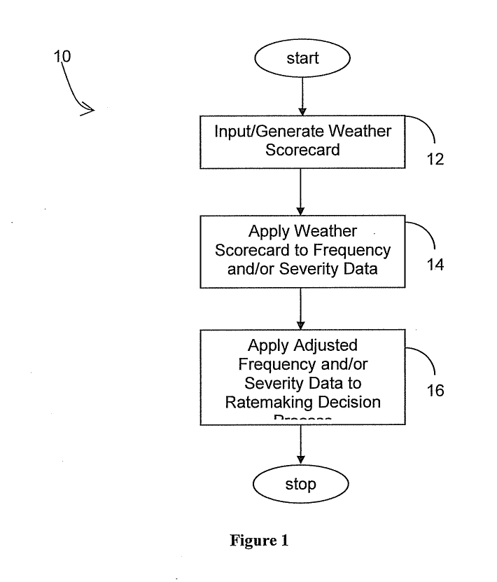

FIG. 1 illustrates an example process 10 according to the disclosed principles for incorporating a weather score process into the ratemaking process for e.g., insurance coverage. It should be appreciated that the process 10 can be used for any type of insurance coverage (personal or commercial, automobile, property, umbrella, etc.) that would benefit from having historical claim frequency, severity or other data adjusted by the past and prospective weather conditions.

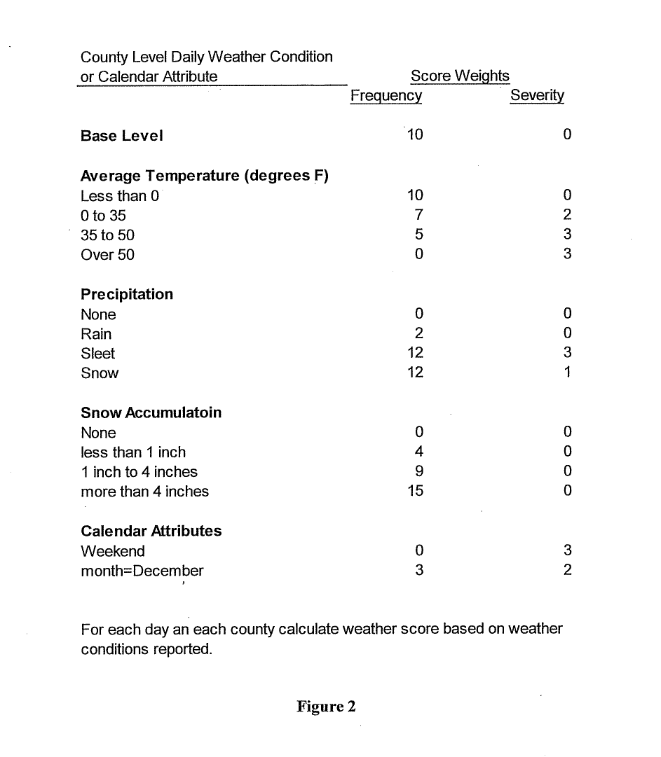

The process 10 begins by inputting or creating a weather scorecard for a particular region over a particular period of time (step 12). The term scorecard is used herein to refer to a list, database, table or other mechanism for accumulating weather scores, etc. and is not intended to be limited to a physical card. FIG. 2 illustrates a sample weather scorecard for a particular county for the month of December. In one embodiment, the FIG. 2 weather scorecard could be used for a personal auto liability insurance ratemaking determination. The weather scorecard consists of weather scores that were computed for each day and county based on reported weather conditions. The illustrated weather scorecard includes weights for claim frequency and severity, which are associated with various categories (e.g., base level, average temperatures, precipitation, snow accumulation, and calendar attributes). As will be discussed below, these weights can be applied to respective historical claim frequency and severity data for the appropriate time period.

As can be seen, each weather category can be broken down into appropriate ranges for the particular category. Each range can have its own weight for claim frequency and/or severity. FIG. 2 illustrates weights for both frequency and severity, which as can be seen, vary for each category/sub-category. The average temperature category has four sub-categories (less than 0° F., 0° F.-35 ° F., 35° F.-50° F., over 50° F.). The precipitation category has four sub-categories (no precipitation, rain, sleet, snow). The snow accumulation category has four sub-categories (no accumulation, less than 1 inch, 1 inch to 4 inches, more than 4 inches). The calendar attributes can be divided into a weekend sub-category and a particular month sub-category. It should be appreciated, however, that the types and number of categories and sub-categories is not limiting and that the embodiments disclosed herein can use as many or as few categories/sub-categories as desired. This scorecard is preferably stored on a computer readable medium so that it can be accessed during process 10 (discussed below) or during the ratemaking process in general.

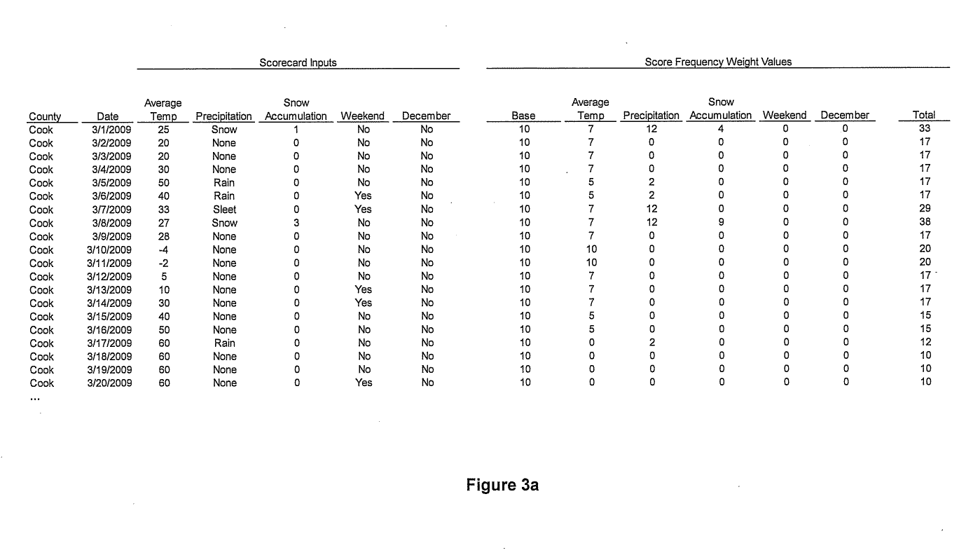

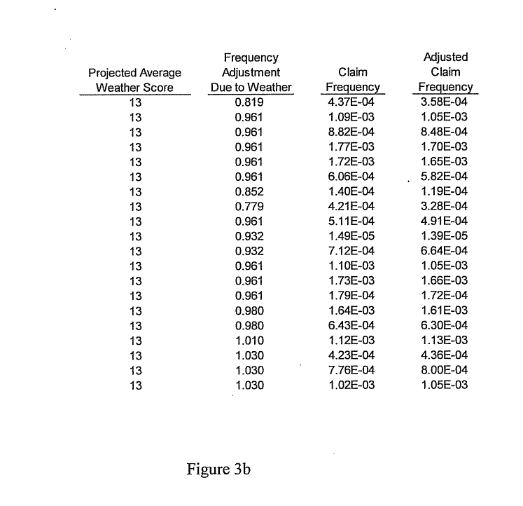

The process 10 continues by applying the appropriate scores of the weather scorecard to the appropriate historical data (step 14). FIGS. 3a-3b illustrate a sample application of the frequency weather scores of a scorecard to a few days' worth of data. Specifically, FIG. 3a illustrates weather scorecard inputs for Cook county on specific days in March 2009 and the associated weather score frequency weight values for those days and weather conditions (based on e.g., a weather scorecard such as the one illustrated in FIG. 2). FIG. 3a also illustrates the total weather score for each day.

FIG. 3b illustrates the projected weather score average and a frequency adjustment weight based on the weather score for the day. The frequency adjustment weight is then applied (e.g., multiplied) to the values in the claim frequency column to achieve the adjusted claim frequency data (step 16). This information is also preferably stored a computer readable medium so that it may be used in the overall ratemaking process.

It should be appreciated that the above process was described with reference to using the weather score process to calculate adjustments to claim frequency data. As described above, the weather score process could be uses to calculate adjustments to claim severity data instead or in addition to the claim frequency adjustments. A practical application of the frequency scorecard would apply frequency adjustments to hundreds or thousands of days in many different counties, or other locations. It should be appreciated that the weather score adjustment to frequency or severity data should not be used as a replacement for existing adjustments used in today's ratemaking techniques. That is, in addition to data adjustments via weather score, there could be adjustments for inflation, changes in the risk environment, and other factors. These adjustments could be compounded with the weather score adjustments to the data.

It should be appreciated that the weather score processing disclosed herein is applicable in any country were weather data is available and insurance prices are set with the intention of having insurance price be proportional to the cost of underwriting insured risk.

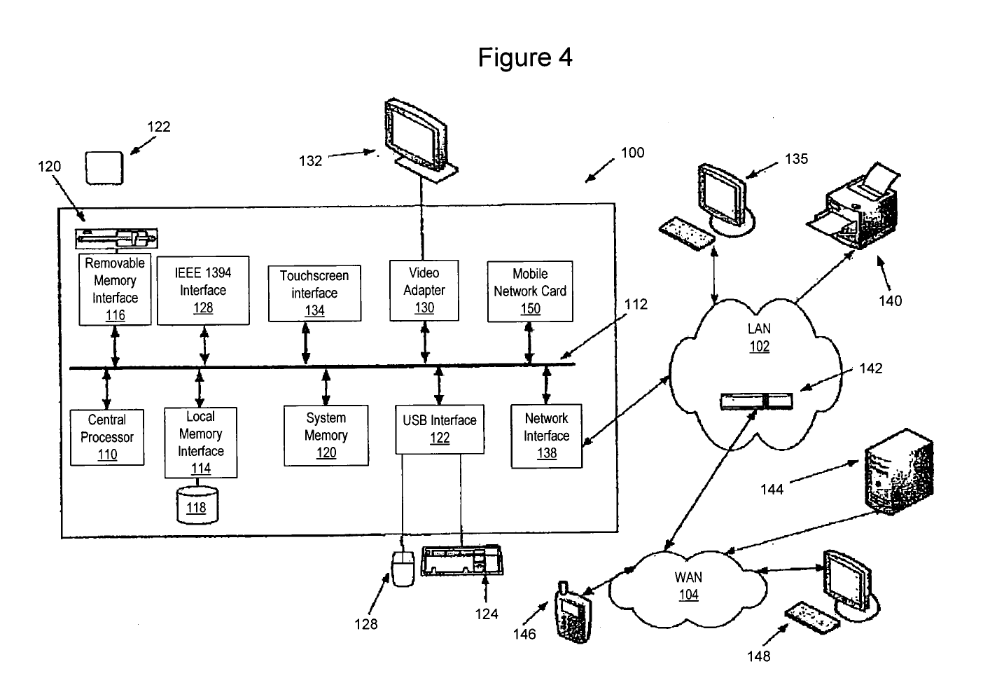

Various examples of the present technology may be implemented with computing device devices, computing device networks and systems that exchange and present information. Elements of an exemplary computing device system are illustrated in FIG. 4, in which the application of weather score to claim frequency and/or severity historical data are provided to a user by a computing device 100. Computing device 100 can be connected to a local area network (LAN) 102 and/or a wide area network (WAN) 104. Computing device 100 can include a central processor 110 that controls the overall operation of the computing device, and a system bus 112 that connects central processor 110 to the components described below. System bus 112 may be implemented with any one of a variety of conventional bus architectures.

Computing device 100 can include a variety of interface units and drives for reading and writing data or files. In particular, computing device 100 can include a local memory interface 114 and a removable memory interface 116 respectively coupling a hard disk drive 118 and a removable memory drive 120 to system bus 112. Examples of removable memory drives include magnetic disk drives and optical disk drives that receive removable memory elements 122. Hard disks generally include one or more read/write heads that convert bits to magnetic pulses when writing to a computing device-readable medium and magnetic pulses to bits when reading data from the computing device readable medium. A single hard disk drive 118 and a single removable memory drive 120 are shown for illustration purposes only and with the understanding that computing device 100 may include several of such drives. Furthermore, computing device 100 may include drives for interfacing with other types of computing device readable media such as magneto-optical drives.

Unlike hard disks, system memories, such as system memory 120, generally read and write data electronically and do not include read/write heads. System memory 120 may be implemented with a conventional system memory having a read only memory section that stores a basic input/output system (BIOS) and a random access memory (RAM) that stores other data and files.

A user can interact with computing device 100 with a variety of input devices, and through graphical user interfaces provided to the user by the computing device 100, such as though a browser application. For example, FIG. 4 shows a universal serial bus (USB) interface 122 coupling a keyboard 124 and a pointing device 126 to system bus 112. Pointing device 132 may be implemented with a hard-wired or wireless mouse, track ball, pen device, or similar device.

Computing device 100 may include additional interfaces for connecting peripheral devices to system bus 112. FIG. 4 shows a IEEE 1394 interface 128 that may be used to couple additional devices to computing device 100. Peripheral devices may include game pads scanners, printers, and other input and output devices and may be coupled to system bus 112 through parallel ports, game ports, PCI boards or any other interface used to couple peripheral devices to a computing device.

Computing device 100 also includes a video adapter 130 coupling a display device 132 to system bus 112. Display device 132 may include a cathode ray tube (CRT), liquid crystal display (LCD), field emission display (FED), plasma display or any other device that produces an image that is viewable by the user. A touchscreen interface 134 may be included to couple a touchscreen (not shown) to system buss 112. A touchscreen may overlay at least part of the display region of display device 132 and may be implemented with a convention touchscreen technology, such as capacitive or resistive touchscreen technology.

One skilled in the art will appreciate that the device connections shown in FIG. 4 are for illustration purposes only and that several of the peripheral devices could be coupled to system bus 112 via alternative interfaces. For example, a video camera could be connected to IEEE 1394 interface 128 and pointing device 126 could be connected to another interface.

Computing device 100 may include a network interface 136 that couples system bus 112 to LAN 102. LAN 102 may have one or more of the well-known LAN topologies and may use a variety of different protocols, such as Ethernet. Computing device 100 may communicate with other computing devices and devices connected to LAN 102, such as computing device 138 and printer 140. Computing devices and other devices may be connected to LAN 102 via twisted pair wires, coaxial cable, fiber optics or other media. Alternatively, electromagnetic waves, such as radio frequency waves, may be used to connect one or more computing devices or devices to LAN 102.

A wide area network 104, such as the Internet, can also be accessed by computing device 100. FIG. 4 shows network interface 136 connected to LAN 102. LAN 102 may be used to connect to WAN 104. FIG. 4 shows a router 142 that may connect LAN 102 to. WAN 104 in a conventional manner. A server 144. Mobile terminal 146 and a computing device 148 are shown connected to WAN 104. Of course, numerous additional servers, computing devices, handheld devices, personal digital assistants, telephones and other devices may also be connected to WAN 104.

In some examples, a mobile network card 150 may be used to connect to LAN 102 and/or WAN 104. Mobile network card may be configured to connect to LAN 102 and/or WAN 104 via a mobile telephone network in a conventional manner.

The operation of computing device 100 and server 144 may be controlled by computing device-executable instructions stored on a non-transient computing device-readable medium. For example, computing device 100 may include computing device-executable instructions stored on a memory for transmitting information to server 144, receiving information from server 144 and displaying the received information on display device 132. Furthermore, server 144 may include stored on a memory computing device-executable instructions for, receiving requests from computing device 100, processing data and transmitting data to computing device 100. In some embodiments server 144 transmits hypertext markup language (HTML) and extensible markup language (XML) formatted data to computing device 100.

As noted above, the term “network” as used herein and depicted in the drawings should be broadly interpreted to include not only systems in which remote storage devices are coupled together via one or more communication paths, but also stand-alone devices that may be coupled, from time to time, to such systems that have storage capability. Consequently, the term “network” includes not only a “physical network” 102 and 104, but also a “content network,” which is comprised of the data—attributable to a single entity—which resides across all physical networks.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A method of adjusting historical data used for insurance ratemaking, said method comprising steps of:
generating, by a computing device, a weather scorecard; and
applying, by the computing device, the weather scorecard to the historical data to generate adjusted historical data.

2. The method of claim 1, wherein the historical data comprises at least one of claim frequency data or claim severity data.

3. The method of claim 1, wherein the weather scorecard comprises a plurality of weather scores for at least one weather condition for a region during a specified period of time.

4. The method of claim 3, wherein each weather score comprises at least one weight value for claim frequency data.

5. The method of claim 3, wherein each weather score comprises at least one weight value for claim severity data.

6. The method of claim 3, wherein each weather score comprises at least one weight value for claim frequency data and claim severity data.

7. The method of claim 3, wherein the at least one weather condition is selected from the group consisting of temperature, precipitation type, and precipitation accumulation.

8. The method of claim 3, wherein the specified period of time is selected from the group consisting of day, weekend, and month.

9. A system for adjusting historical data used for insurance ratemaking, said system comprising:
a storage medium for storing the historical data; and
a processor programmed to generate a weather scorecard and apply the weather scorecard to the historical data to generate adjusted historical data.

10. The system of claim 9, wherein the historical data comprises at least one of claim frequency data or claim severity data.

11. The system of claim 9, wherein the weather scorecard comprises a plurality of weather scores for at least one weather condition for a region during a specified period of time.

12. The system of claim 11, wherein each weather score comprises at least one weight value for claim frequency data.

13. The system of claim 11, wherein each weather score comprises at least one weight value for claim severity data.

14. The system of claim 11, wherein each weather score comprises at least one weight value for claim frequency data and claim severity data.

15. The system of claim 11, wherein the at least one weather condition is selected from the group consisting of temperature, precipitation type, and precipitation accumulation.

16. The system of claim 11, wherein the specified period of time is selected from the group consisting of day, weekend, and month.

17. The system of claim 9, wherein the storage medium stores the weather scorecard and the adjusted historical data.
